(19) United States
(12) Patent Application Publication
(10) Pub. No.: US 2005/0144836 A1
(43) Pub. Date: Jul. 7, 2005

(54) Sunshade having more than two heat-dissipating portions formed from weft yarns

(76) Inventor: Ming-Hsien Ko, Chang-Hua Hsien (TW)

Correspondence Address: LADAS & PARRY LLP, 224 SOUTH MICHIGAN AVENUE, SUITE 1200, CHICAGO, IL, 60604, US

(21) Appl. No.: 10/749,172

(22) Filed: Dec. 30, 2003

(51) Int. Cl. A01G 13/02

(52) U.S. Cl. 47/31

(57) ABSTRACT

A sunshade includes a first net body, a second net body, and a curtain body. The first net body includes a first connecting portion, a first shading portion, and a first heat-dissipating portion. The first shading portion includes weft yarns and warp yarns interlaced with the weft yarns. The first heat-dissipating portion includes weft yarns. The second net body includes a second connecting portion, a second shading portion, and a second heat-dissipating portion. The second shading portion includes weft yarns and warp yarns interlaced with the weft yarns of the second shading portion. The second heat-dissipating portion includes weft yarns. The curtain body includes a third connecting portion and a third heat-dissipating portion connected to the third connecting portion. The third heat-dissipating portion includes weft yarns. The first, second and third connecting portions are connected together.

### BACKGROUND OF THE INVENTION

1. Field of the Invention

The invention relates to a sunshade, more particularly to a sunshade to be hung above the ground using a pair of parallel strings that extend in a horizontal direction.

2. Description of the Related Art

U.S. Pat. No. 6,421,954 B2 discloses a sunshade, which includes an intermediate net portion, two stringing sections formed on two sides of the intermediate net portion and each having a limit portion which is interposed between two warp-free portions, two opposite drape portions extending from the stringing sections, respectively, and a pair of strings threading through and fastening together the warp-free portions of the respective stringing section. The following are some of the disadvantages of the aforesaid sunshade:

1. Since the heat radiated from the field underneath the sunshade is absorbed by the drape portions and is then dissipated when the drape portions are blown by the wind, the heat absorbing effect of the prior art is relatively limited because only two drape portions are provided for each sunshade of the prior art.

2. Because of the aforesaid limitation, the total number of the sunshades required to cover a given area and to achieve a desirable heat absorbing effect is relatively increased. Therefore, the costs and labor involved in installing the aforesaid sunshade are high.

### SUMMARY OF THE INVENTION

The main object of the present invention is to provide a sunshade that is capable of overcoming the aforesaid disadvantages of the prior art.

A sunshade according to this invention is hung above the ground using a pair of parallel strings that extend in a horizontal direction. The sunshade includes a first net body, a second net body, and a curtain body.

The first net body includes a first connecting portion, a first shading portion, and a first heat-dissipating portion. The first shading portion is disposed between the first connecting portion and the first heat-dissipating portion. The first shading portion includes a plurality of weft yarns and a plurality of warp yarns interlaced with the weft yarns. The first heat-dissipating portion includes a plurality of weft yarns.

The second net body includes a second connecting portion, a second shading portion, and a second heat-dissipating portion. The second shading portion is disposed between the second connecting portion and the second heat-dissipating portion. The second shading portion includes a plurality of weft yarns and a plurality of warp yarns interlaced with the weft yarns of the second shading portion. The second heat-dissipating portion includes a plurality of weft yarns.

The curtain body includes a third connecting portion and a third heat-dissipating portion connected to the third connecting portion. The third heat-dissipating portion includes a plurality of weft yarns. The first connecting portion, the second connecting portion and the third connecting portion are connected together.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of the first preferred embodiment of the sunshade according to this invention;

FIGS. 2 to 5 are schematic sectional views illustrating consecutive steps for installing the sunshade of the first preferred embodiment; and

FIG. 6 is a schematic sectional view of the second preferred embodiment of the sunshade according to this invention.

### DETAILED DESCRIPTION OF THE PREFERRED EMBODIMENTS

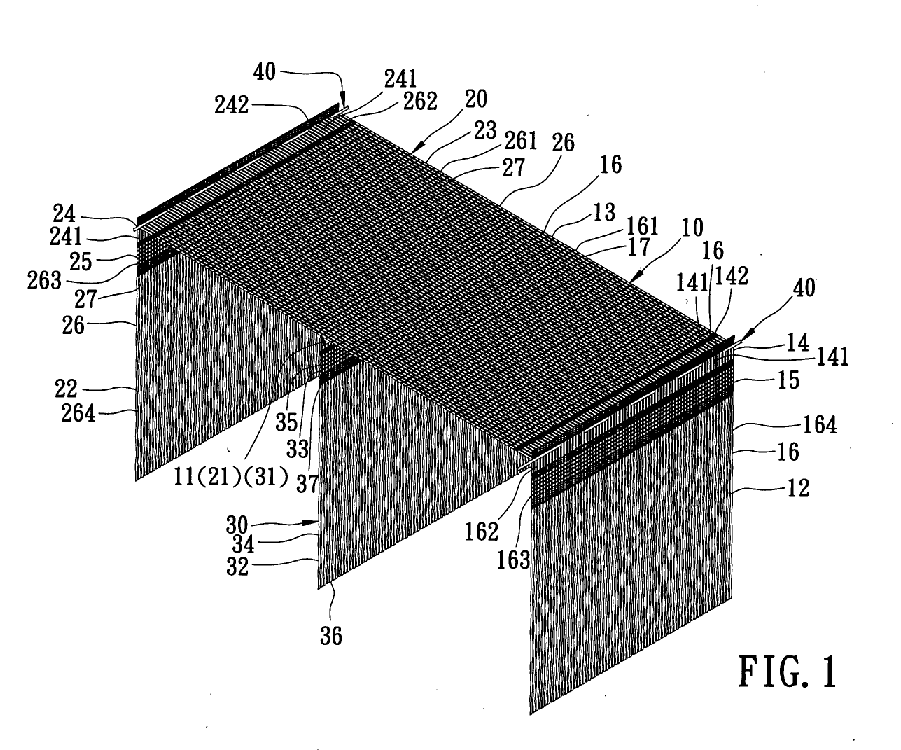

Referring to FIG. 1, the first preferred embodiment of the sunshade according to this invention is to be hung above the ground, and is shown to include a pair of parallel strings 40, a first net body 10, a second net body 20, and a curtain body 30.

The strings 40 are disposed above the ground and extend in a horizontal direction.

The first net body 10 is a woven net fabric made of a plastic material, such as PVC, PE, etc., and includes a first connecting portion 11, a first shading portion 13, a first stringing portion 14, a first positioning portion 15, and a first heat-dissipating portion 12. The first shading portion 13 is disposed between and is connected to the first connecting portion 11 and the first stringing portion 14. The first stringing portion 14 is disposed between and is connected to the first shading portion 13 and the first positioning portion 15. The first positioning portion 15 is disposed between and is connected to the first stringing portion 14 and the first heat-dissipating portion 12. The first shading portion 13 includes a plurality of weft yarns 161 and a plurality of warp yarns 17 interlaced with the weft yarns 161. The first stringing portion 14 has a plurality of weft yarns 162 and includes two warp-free stringing sections 141 and a warp-interlaced limit section 142 disposed between and connected to the stringing sections 141. The first heat-dissipating portion 12 is a warp-free portion and includes a plurality of the weft yarns 164. The first positioning portion 15 includes a plurality of weft yarns 163 connected respectively to the weft yarns 164 of the first heat-dissipating portion 12, and a plurality of warp yarns 17 interlaced with the weft yarns 163 of the first positioning portion 15. In this embodiment, each of the weft yarns 161 of the first shading portion 13 is integrated with a corresponding one of the weft yarns 162 of the first stringing portion 14, a corresponding one of the weft yarns 163 of the first positioning portion 15, and a corresponding one of the weft yarns 164 of the first heat-dissipating portion 12 to form a continuous weft yarn 16.

The second net body 20 is also a woven net fabric made of a plastic material, such as PVC, PE, etc., and includes a second connecting portion 21, a second shading portion 23, a second stringing portion 24, a second positioning portion 25, and a second heat-dissipating portion 22. The second shading portion 23 is disposed between and is connected to the second connecting portion 21 and the second stringing portion 24. The second stringing portion 24 is disposed between and is connected to the second shading portion 23 and the second positioning portion 25. The second positioning portion 25 is disposed between and is connected to the second stringing portion 24 and the second heat-dissipating portion 22. The second shading portion 23 includes a plurality of weft yarns 261 and a plurality of warp yarns 27 interlaced with the weft yarns 261 of the second shading portion 23. The second stringing portion 24 has a plurality of weft yarns 262 and includes two warp-free stringing sections 241 and a warp-interlaced limit section 242 disposed between and connected to the stringing sections 241. The second heat-dissipating portion 22 is a warp-free portion and includes a plurality of the weft yarns 264. The second positioning portion 25 includes a plurality of weft yarns 263 connected respectively to the weft yarns 264 of the second heat-dissipating portion 22, and a plurality of warp yarns 27 interlaced with the weft yarns 263 of the second positioning portion 25. In this embodiment, each of the weft yarns 261 of the second shading portion 23 is integrated with a corresponding one of the weft yarns 262 of the second stringing portion 24, a corresponding one of the weft yarns 263 of the second positioning portion 25, and a corresponding one of the weft yarns 264 of the second heat-dissipating portion 22 to form a continuous weft yarn 26.

The curtain body 30 is similarly a woven fabric made of a plastic material, such as PVC, PE, etc., and includes a third connecting portion 31 and a third heat-dissipating portion 32 connected to the third connecting portion 31. The third heat-dissipating portion 32 is a warp-free portion and includes a plurality of weft yarns 34. The curtain body 30 further includes a positioning portion 33 that is disposed between and that interconnects the third connecting portion 31 and the third heat-dissipating portion 32. The positioning portion 33 includes a plurality of weft yarns 35 connected respectively to the weft yarns 34 of the third heat-dissipating portion 32, thereby forming a plurality of continuous weft yarns 36, and a plurality of warp yarns 37 interlaced with the weft yarns 35 of the positioning portion 33.

In the preferred embodiment, the weft yarns 16,26,36 are flat, and the warp yarns 17,27,37 are mono filament circular warp yarns.

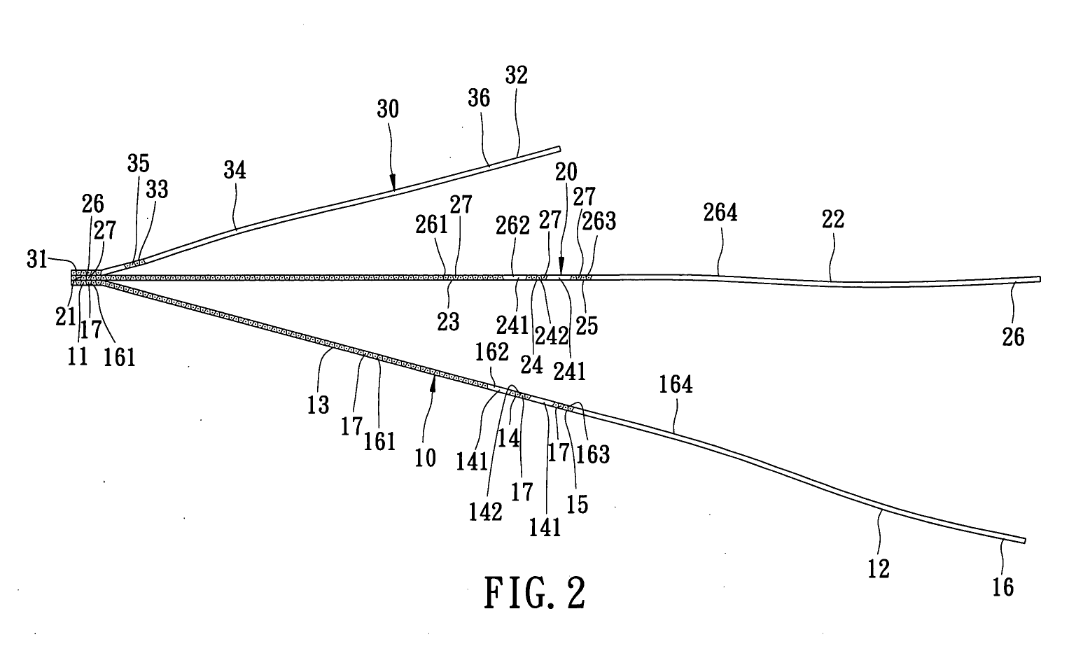

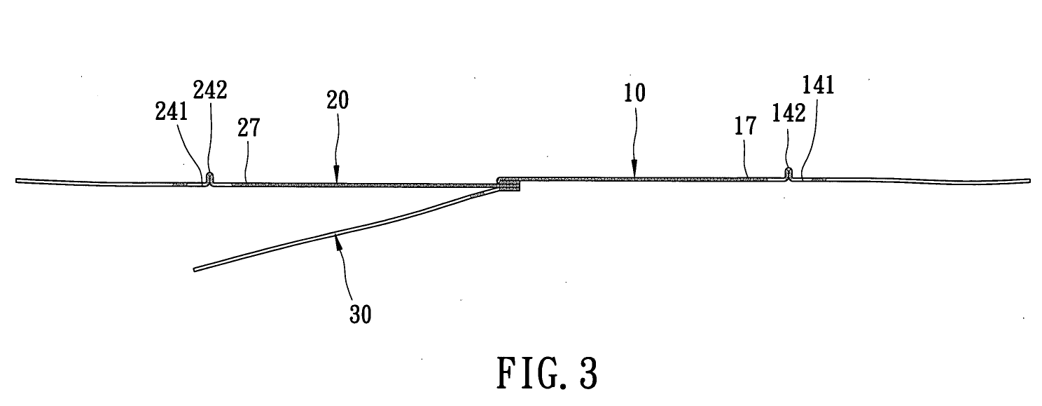

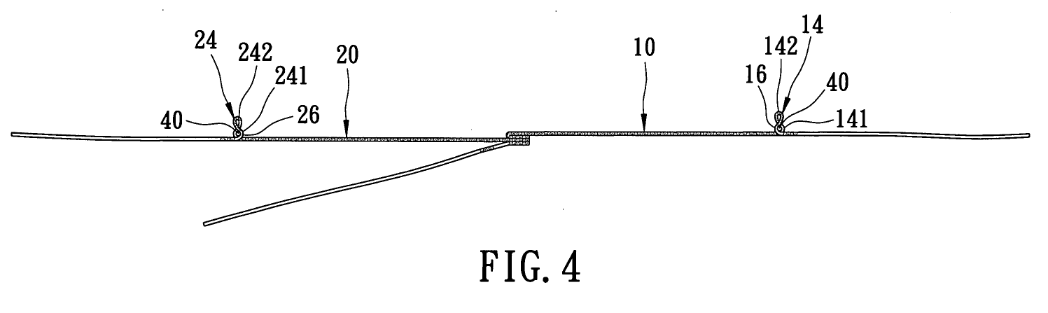

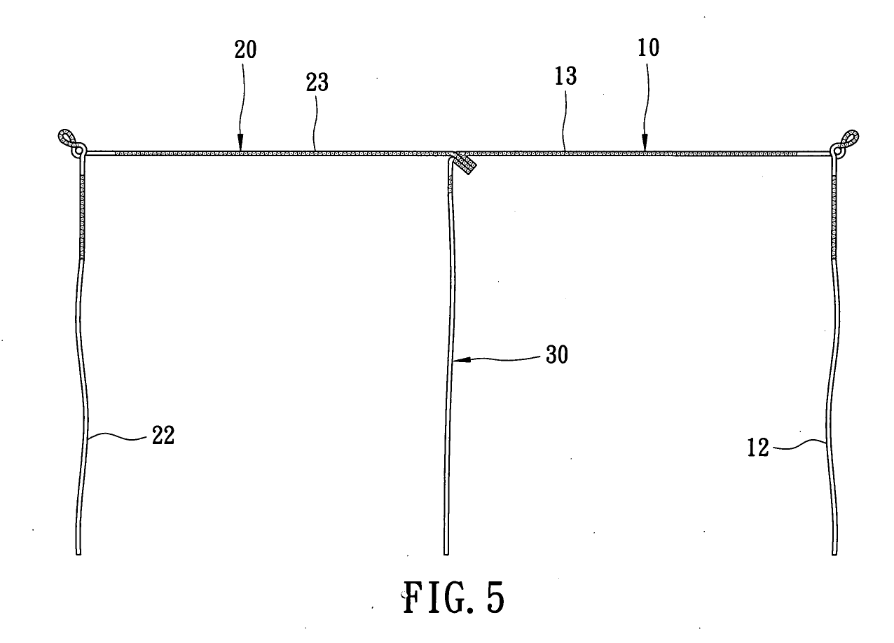

The first connecting portion 11, the second connecting portion 21 and the third connecting portion 31 are connected together. In the preferred embodiment, the first, second and third connecting portions 11,21,31 are connected fixedly to one another by weaving. Referring to FIGS. 2 to 5, when installing the sunshade of this embodiment, the first and second net bodies 10,20 are turned apart from a state shown in FIG. 2 to a state shown in FIG. 3. Thereafter, referring to FIG. 4, the strings 40 are extended respectively through the first and second stringing portions 14,24 of the first and second net bodies 10,20 such that the strings 40 thread through and fasten together the warp-free stringing sections 141,241 of the respective one of the first and second stringing portions 14,24. When the sunshade is hung above the ground, the first and second shading portions 13, 23 are stretched apart, and the first, second and third heat-dissipating portions 12,22,32 extend downwardly toward the ground for providing a heat-dissipating effect, as best shown in FIG. 5.

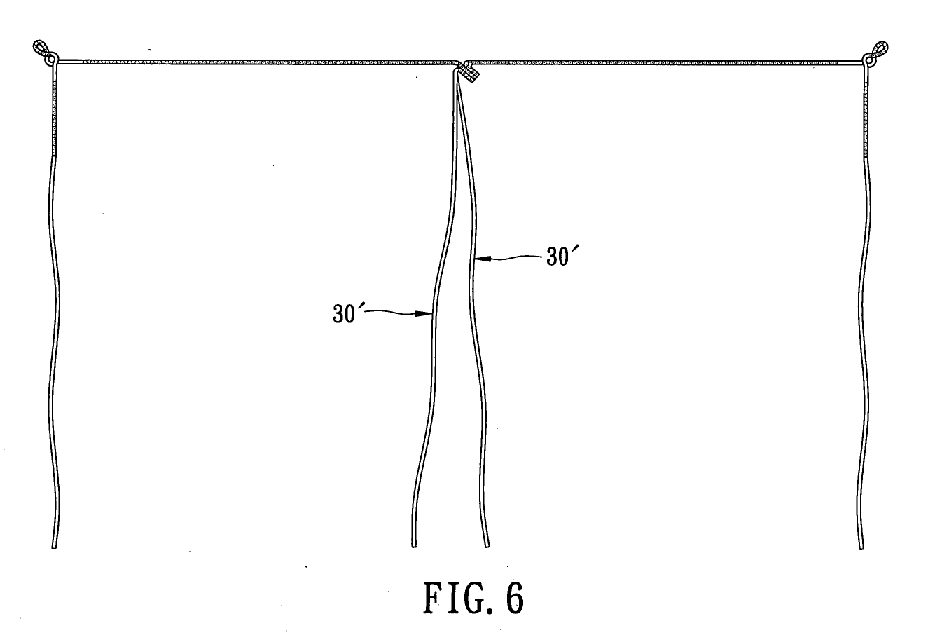

Referring to FIG. 6, the second preferred embodiment of the sunshade according to this invention is shown to be similar to the first preferred embodiment, except that two curtain bodies 30′ are included in the second embodiment so as to further enhance the heat-dissipating effect.

In view of the foregoing, as compared to the sunshade disclosed in the aforesaid U.S. patent, the total length of the first and second shading portions 13,23 of the first and second net bodies 10,20 of the sunshade of this invention can be increased while maintaining a good heat-dissipating effect by providing a curtain body 30 that is disposed between the first and second heat-dissipating portions 12,22 when the sunshade is hung above the ground. Furthermore, the total number of the sunshades required to cover a given area can be reduced to result in lower cost and labor requirements during installation.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A sunshade comprising:
a first net body including a first connecting portion, a first shading portion, a first heat-dissipating portion, and a first stringing portion, said first shading portion being disposed between said first connecting portion and said first heat-dissipating portion and including a plurality of weft yarns and a plurality of warp yarns interlaced with said weft yarns, said first heat-dissipating portion being a warp-free portion and including a plurality of weft yarns, said first stringing portion being disposed between said first shading portion and said first heat-dissipating portion;
a second net body including a second connecting portion, a second shading portion, a second heat-dissipating portion, and a second stringing portion, said second shading portion being disposed between said second connecting portion and said second heat-dissipating portion and including a plurality of weft yarns and a plurality of warp yarns interlaced with said weft yarns of said second shading portion, said second heat-dissipating portion being a warp-free portion and including a plurality of weft yarns, said second stringing portion being disposed between said second shading portion and said second heat-dissipating portion; and
a curtain body including a third connecting portion and a third heat-dissipating portion connected to said third connecting portion, said third heat-dissipating portion being a warp-free portion and including a plurality of weft yarns;
wherein said first connecting portion, said second connecting portion and said third connecting portion are connected together, each of said first and second stringing portions of said first and second net bodies being adapted to permit extension of a respective string therethrough.

2. The sunshade of claim 1, wherein said weft yarns of each of said first and second shading portions are flat, and said warp yarns of each of said first and second shading portions are mono filament circular warp yarns.

3. The sunshade of claim 1, wherein said first, second and third connecting portions are woven together.

4. The sunshade of claim 1, wherein each of said first and second net bodies further includes a positioning portion disposed between and connected to a corresponding one of said first and second stringing portions and a corresponding one of said first and second heat-dissipating portions, said positioning portion including a plurality of weft yarns connected respectively to said weft yarns of the corresponding one of said first and second heat-dissipating portions, and a plurality of warp yarns interlaced with said weft yarns of said positioning portion.

5. The sunshade of claim 1, wherein said curtain body further includes a positioning portion that is disposed between and that interconnects said third connecting portion and said third heat-dissipating portion, said positioning portion including a plurality of weft yarns connected respectively to said weft yarns of said third heat-dissipating portion, and a plurality of warp yarns interlaced with said weft yarns of said positioning portion.

6. The sunshade of claim 1, wherein each of said first and second stringing portions includes two warp-free stringing sections and a warp-interlaced limit section disposed between and connected to said stringing sections.

7. A sunshade adapted to be hung above the ground using a pair of parallel strings that extend in a horizontal direction, said sunshade comprising:
a first net body including a first connecting portion, a first shading portion, a first stringing portion, and a first heat-dissipating portion, said first shading portion being disposed between and being connected to said first connecting portion and said first stringing portion, said first stringing portion being disposed between said first shading portion and said first heat-dissipating portion, said first shading portion including a plurality of weft yarns and a plurality of warp yarns interlaced with said weft yarns, said first heat-dissipating portion being a warp-free portion and including a plurality of weft yarns;
a second net body including a second connecting portion, a second shading portion, a second stringing portion, and a second heat-dissipating portion, said second shading portion being disposed between and being connected to said second connecting portion and said second stringing portion, said second stringing portion being disposed between said second shading portion and said second heat-dissipating portion, said second shading portion including a plurality of weft yarns and a plurality of warp yarns interlaced with said weft yarns of said second shading portion, said second heat-dissipating portion being a warp-free portion and including a plurality of weft yarns;
a curtain body including a third connecting portion and a third heat-dissipating portion connected to said third connecting portion, said third heat-dissipating portion being a warp-free portion and including a plurality of weft yarns;
wherein said first connecting portion, said second connecting portion and said third connecting portion are connected together;
said first and second stringing portions of said first and second net bodies being adapted to permit extension of the strings respectively therethrough;
whereby, said first and second shading portions are stretched apart and said first, second and third heat-dissipating portions extend downwardly toward the ground for providing a heat-dissipating effect when said sunshade is hung above the ground.

8. The sunshade of claim 7, wherein said weft yarns of each of said first and second shading portions are flat, and said warp yarns of each of said first and second shading portions are mono filament circular warp yarns.

9. The sunshade of claim 7, wherein said first, second and third connecting portions are woven together.

10. The sunshade of claim 7, wherein each of said first and second net bodies further includes a positioning portion disposed between and connected to a corresponding one of said first and second stringing portions and a corresponding one of said first and second heat-dissipating portions, said positioning portion including a plurality of weft yarns connected respectively to said weft yarns of the corresponding one of said first and second heat-dissipating portions, and a plurality of warp yarns interlaced with said weft yarns of said positioning portion.

11. The sunshade of claim 7, wherein said curtain body further includes a positioning portion that is disposed between and that interconnects said third connecting portion and said third heat-dissipating portion, said positioning portion including a plurality of weft yarns connected respectively to said weft yarns of said third heat-dissipating portion, and a plurality of warp yarns interlaced with said weft yarns of said positioning portion.

12. The sunshade of claim 7, wherein each of said first and second stringing portions includes two warp-free stringing sections and a warp-interlaced limit section disposed between and connected to said stringing sections.

13. A sunshade comprising:
a pair of parallel strings adapted to be disposed above the ground and to extend in a horizontal direction;
a first net body including a first connecting portion, a first shading portion, a first stringing portion, and a first heat-dissipating portion, said first shading portion being disposed between and being connected to said first connecting portion and said first stringing portion, said first stringing portion being disposed between said first shading portion and said first heat-dissipating portion, said first shading portion including a plurality of weft yarns and a plurality of warp yarns interlaced with said weft yarns, said first heat-dissipating portion being a warp-free portion and including a plurality of weft yarns;
a second net body including a second connecting portion, a second shading portion, a second stringing portion, and a second heat-dissipating portion, said second shading portion being disposed between and being connected to said second connecting portion and said second stringing portion, said second stringing portion being disposed between said second shading portion and said second heat-dissipating portion, said second shading portion including a plurality of weft yarns and a plurality of warp yarns interlaced with said weft yarns of said second shading portion, said second heat-dissipating portion being a warp-free portion and including a plurality of weft yarns; and
a curtain body including a third connecting portion and a third heat-dissipating portion connected to said third connecting portion, said third heat-dissipating portion being a warp-free portion and including a plurality of weft yarns;
wherein said first connecting portion, said second connecting portion and said third connecting portion are connected together;
said strings being extended respectively through said first and second stringing portions of said first and second net bodies such that said first and second shading portions are stretched apart and such that said first, second and third heat-dissipating portions extend downwardly toward the ground for providing a heat-dissipating effect when said sunshade is hung above the ground.
